(19) United States
(12) Patent Application Publication
(10) Pub. No.: US 2004/0186812 A1
(43) Pub. Date: Sep. 23, 2004

(54) Method for determining a billing target

(76) Inventors: Gap-Chun Back, Gyeonggi-do (KR); Seung-Hyouk Yim, Songpa-gu (KR); Terry Ahn, Gangnam-gu (KR); Chil-Hyun Baek, Seoul (KR)

Correspondence Address: Finnegan Henderson Farabow, Garrett & Dunner, 1300 I Street NW, Washington, DC, 20005, US

(21) Appl. No.: 10/485,729

(22) PCT Filed: Aug. 13, 2002
(86) PCT No.: PCT/KR02/01542

(30) Foreign Application Priority Data
Aug. 13, 2001 (KR) 2001/48768

(51) Int. Cl. G06F 17/60

(52) U.S. Cl. 705/412

(57) ABSTRACT

The present invention relates to a method for determining a billing target in employees' terminal in order to bill the communication charges. According to the present invention, there is a method for determining a billing target in a first subscriber's terminal in order to bill the first subscriber's communication charge, the method comprising the steps of: receiving a business connection data from a second subscriber corresponding to the first subscriber, wherein the business connection data comprises business connection access information and billing target information for billing, storing the received business connection data in a storage and updating the billing target by use of the billing target information, wherein the charge for communication service through the business connection access information is billed the billing target.

### FIELD OF THE INVENTION

The present invention relates to a method for determining a billing target in employees' terminal in order to bill the communication charges.

### BACKGROUND OF THE INVENTION

FIG. 1A and FIG. 1B schematically represents the conventional method for billing communication charges.

Referring to FIG. 1A, communication service provider 101 bills a subscriber 105 as a billing target for a communication service charge for all communication services used by the service subscriber 105. In this case, the service provider does not consider whether or not the subscriber 105 is an employee of the company 103 and the subscriber 105 uses the communication server for doing official business. The subscriber 103, as an employee of the company 105, demands a portion of the paid charge for doing official business to the company 103 separately. In this case, however, it is not to estimate the charge for doing official business from the communication service charge for all communication services. Rather, there are some cases in which the company has to pay some portion of the charges for non-officially-used services. In other words, even though the subscriber 105 uses the communication service related to the company 103, there are some cases in which the subscriber 105 has to pay the charge for the official business.

Referring to FIG. 1B, if the service subscriber 103, as an employee of a company 103, uses the communication service related to the official business, the communication service provider directly bills the company 105 for the charges of each employee. In this case, however, the communication service provider has a burden of managing subscribers' information and company information together in order to directly bill the company 103 for the charges of each employee. That is, there must be a change in the billing system of the communication service provider.

### DISCLOSURE OF THE INVENTION

The present invention is for overcoming the aforementioned problems. The primary objective of the present invention is to provide a method for determining a billing target and a terminal thereof, which can allow a company to save expenses by billing the company for charges only corresponding to official business.

Another objective of the present invention is to provide a method for determining a billing target and a terminal thereof, which can eliminate the burden on behalf of the employees, since they will not have to pay the charges for services related to official business even if the employee uses his/her terminal.

Still another objective of the present invention is to provide a method for determining a billing target and a terminal thereof, which can divide and bill a billing target in a SMS and a wireless data communication service as well as a conventional voice call.

Still another objective of the present invention is to provide a method for determining a billing target and a terminal thereof, which, because of changing a billing target according to change in the terminal's software, is not needed to change the conventional billing system provided with a plurality of switchboards and wireless data communication equipments of the service provider and, as a result, can save the cost required to change the billing system.

Yet another objective of the present invention is to provide a method for determining a billing target and a terminal thereof, which can change the billing target collectively by use of PIMS data in the forms of vCard or SMS without changing the billing target one-by-one.

To achieve the aforementioned objectives, according to the preferred embodiment of the present invention, there is provided a method for determining a billing target in a first subscriber's terminal in order to bill the first subscriber's communication charge, the method comprising the steps of: receiving a business connection data from a second subscriber corresponding to the first subscriber, wherein the business connection data comprises business connection access information and billing target information for billing, storing the received business connection data in a storage and updating the billing target by use of the billing target information, wherein the charge for communication service through the business connection access information is billed the billing target. Also, there is provided a computer-readable medium corresponding to the method for determining a billing target.

The business connection data is PIMS(Personal Information Management System) data that is selected from a group consisting of vCard form and SMS(Short Message Service) form, wherein the terminal is provided with PIMS. Here, the business connection data can be received through at least one method selected from a group consisting of a wireless data communication method, a SMS method and a SMS call-back method.

The business connection data further comprises a billing-application period.

The business connection access information is one selected from a group consisting of a business connection telephone number, a business connection URL. the billing target information is one selected from a group consisting of a second subscriber representative information for updating the second subscriber as a billing target and a deletion information for deleting the second subscriber from the billing target. The second subscriber representative information is a representative telephone number corresponding to the second subscriber.

According to another preferred embodiment of the present invention, there is provided a terminal for determining a billing target in a first subscriber's terminal in order to bill the first subscriber's communication charge, said terminal comprising: means for receiving a business connection data from a second subscriber corresponding to the first subscriber, wherein the business connection data comprises business connection access information and billing target information for billing, means for storing the received business connection data in a storage and means for updating the billing target by use of the billing target information, wherein the charge for communication service through the business connection access information is billed the billing target.

According to still another preferred embodiment of the present invention, there is provided a method for providing a business connection data for determining a billing target in a terminal of a second subscriber corresponding to a first subscriber in order to bill the first subscriber's communication charge, said method comprising the steps of: extracting the business connection data from a business connection database, processing the extracted business connection data and transmitting the processed business connection data to a terminal corresponding to the first subscriber, wherein the business connection data comprises business connection access information and billing target information for billing, wherein the business connection data is stored in the terminal, the billing target is updated by use of the billing target information and the charge for communication service through the business connection access information is billed the billing target.

### BRIEF DESCRIPTION OF THE DRAWINGS

FIG. 1A and FIG. 1B schematically represent conventional method for billing communication charge.

FIG is a schematic of billing system for communication charge in accordance with the preferred embodiment of the present invention.

FIG. 3 is a schematic of the system of the communication service provider in accordance with the preferred embodiment of the present invention.

FIG. 4 is a schematic of the system of the company in accordance with the preferred embodiment of the present invention.

FIG. 5a shows vCard data fields in accordance with the preferred embodiment of the present invention.

FIG. 5b shows PIMS data according to the vCard form in accordance with the preferred embodiment of the present invention.

FIG. 6a shows fields of SMS data in accordance with the preferred embodiment of the present invention.

FIG. 6b and FIG. 6c show PIMS data according to SMS form in accordance with the preferred embodiment of the present invention.

FIG. 7 is a schematic of the employee's terminal in accordance with the preferred embodiment of the present invention.

FIG. 8 is a flow chart for showing the process of determining the billing target in accordance with the preferred embodiment of the present invention.

FIG. 9a is a flow chart showing the method for changing the billing target in using a voice call service and SMS in accordance with the preferred embodiment of the present invention.

FIG. 9b is a flow chart showing the method for changing the billing target in using a wireless data communication service in accordance with the preferred embodiment of the present invention.

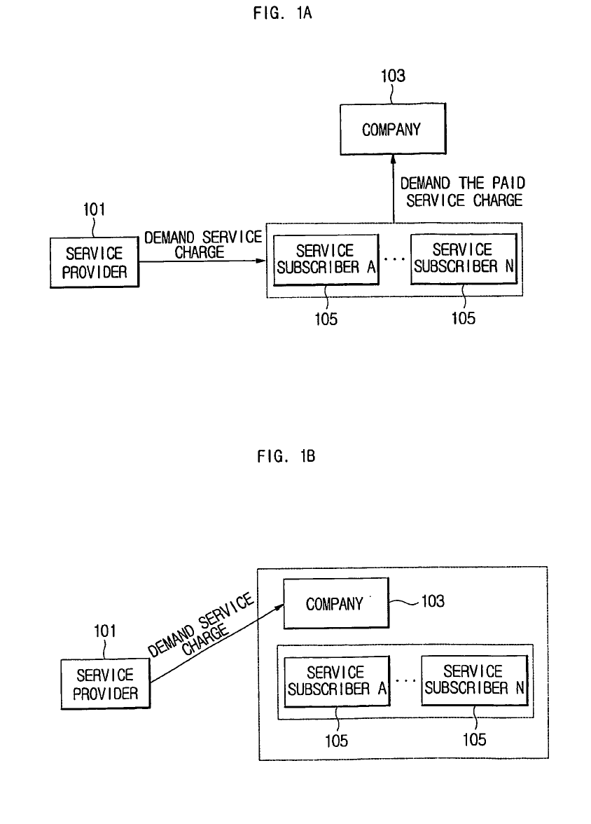

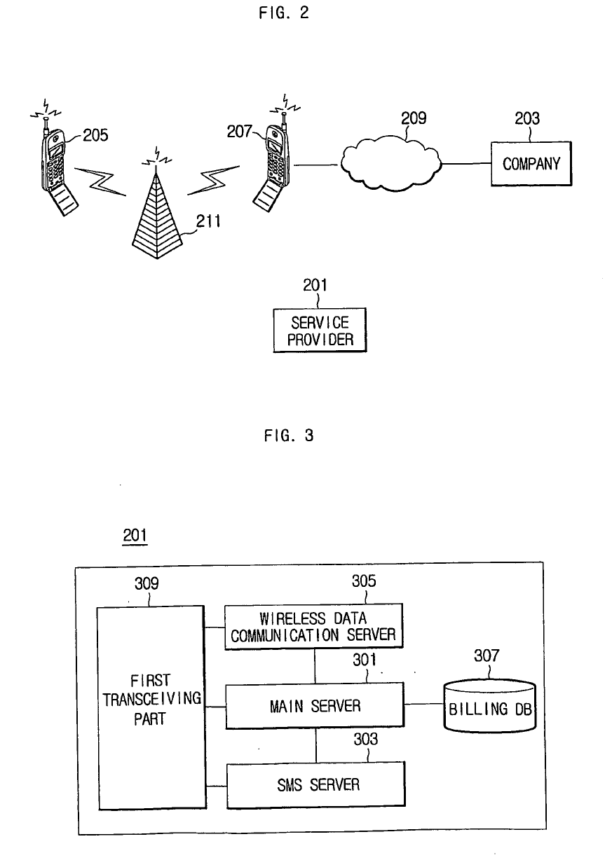

### DETAILED DESCRIPTION OF THE PREFERRED EMBODIMENTS

Hereinafter, the preferred embodiment of the present invention will be described with accompanying drawings.

FIG. 2 is a schematic of billing system for communication charge in accordance with the preferred embodiment of the present invention.

Referring to FIG. 2, the employee terminal 207 is connected to the company 203, which the employee works for, through communication networks, especially intranet 209 and is connected to the receiver's terminal 205 through the repeater (or base station) 211 by using the communication service provided by the communication service provider 201. The communication service provider 201 bills the billing target set up in the employee's terminal 207 for the communication charge on the basis of call detailed records(CDR) related to the employee's terminal 207. In the preferred embodiment of the present invention, when the employee uses the communication service for an official business of the company 203 by the employee's terminal 207, the communication charge for the company is billed to the company 203. Hereinafter, the method for determining the billing target will be described. The schematic of the company 203 and the employee's terminal 207 for determining the billing target will be described later with accompanying drawings.

The method for determining the billing target can be described roughly as follow:

At first, the company 203 extracts business connection data for smoothly performing their tasks from the business connection database. Here, it is preferable to update business connection data periodically. Then, the company 203 processes extracted business connection data to be recognized by the employee's terminal 207. As an example, the business connection data is processed to have a form of vCard or SMS that can be recognized by PIMS(Personal Information Management System) in the employee's terminal 207. The forms of business connection data, PIMS, vCards and SMS will be described later. Then the company 203 transmits processed business connection data to the employee's terminal 207. As an example of transmission, there are several ways such as a wireless data communication method, a SMS method and a SMS call-back method, and detailed description on theses methods will be described later.

The employee's terminal 207 receives processed business connection data transmitted from the company 203 by the wireless data communication method, the SMS method or the SMS call-back method. The employee's terminal extracts business connection data from processed business connection data received from the company 203. Then, the employee' terminal 207 stores extracted business connection data in the address book of the storage.

Here, business connection data may be comprised of billing target information, a business connection name, business connection access information (business connection telephone number or URL) and a billing application period. Billing target information is for determining the billing target to whom is billed the communication charge when the employee uses the communication service by use of business connection access information. Billing target information may be one selected from a group consisting of representative company information and deletion information. Representative company information is for updating the company 203 as the billing target and as an example, may be the representative telephone number. Deletion information is for deleting the company 203 from the billing target when the company is already set up for the billing target.

Then, the employee's terminal 207 updates the billing target by use of billing target information in business connection data. When the employee uses the communication service by use of business connection data, the communication charge according to the use of communication service is billed to the updated billing target. That is, the communication service provider 201 recognizes the updated billing target as a billing target and then comes to bill the updated billing target for the communication charge.

FIG. 3 is a schematic of the system of the communication service provider in accordance with the preferred embodiment of the present invention.

Referring to FIG. 3, the system of the communication service provider 201 comprises a main server 301, a SMS server 303, a wireless data communication server 305, a billing database 307 and the first transceiving part 309. The main server 301 performs overall mobile communication service for a plurality of mobile communication terminals. The SMS server 303 performs a short message service(SMS) for the plurality of mobile communication terminals. And the wireless data communication server 305 performs a wireless communication service that makes the plurality of mobile communication terminals communicate wireless data by accessing Internet or intranet. Each server is conventionally used, so detailed description will be omitted.

The billing database 307 stores particulars for communication service use. The particulars for communication service use comprise a subscriber, a use period, a billing target, a billing ratio and so on. The billing database is also conventionally used, so detailed description will be omitted.

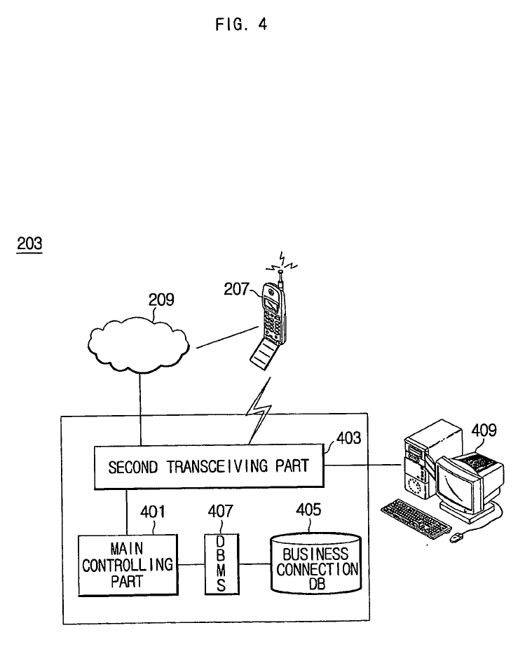

FIG. 4 is a schematic of the system of the company in accordance with the preferred embodiment of the present invention.

Referring to FIG. 4, the system of the company 203 comprises main controlling part 401, the second transceiving part 403, a business connection database 405 and DBMS(database management system) 407.

DBMS 407 is a program that lets a supervisor create and access data in the business connection database 405 through the supervisor's terminal 409. DBMS 407 manages supervisor requests (and requests from other programs) so that users and other programs are free from having to understand where the data is physically located on storage and, in a multi-user system, who else may also be accessing the data. In handling user requests, DBMS 407 ensures the integrity of the data and security. Integrity makes sure it continues to be accessible and is consistently organized as intended. Also, security makes sure only those with access privileges can access the data. The most typical DBMS 407 is a relational database management system(RDBMS). A standard user and program interface of RDBMS is the Structured Query Language (SQL). A newer kind of DBMS 405 is the object-oriented database management system (OODBMS).

The business connection database 405 is a storage space that the DBMS can create or access data. The business connection database 405 comprises business connection data. Business connection comprises a business connection name, a telephone number, a fax number, URL and so on. Business connection data further comprises billing target information and a billing application period The second transceiving part 403 lets the employee's terminal access intranet 209 or mobile networks 209 and access supervisor's terminal 409.

The main controlling part 401 performs a function of generally controlling DBMS 407, the business connection database 405 and the second transceiving part 403. Also, the main controlling part 403 performs a function of processing business connection data extracted from the business connection database 405. Business connection data is processed to be a form of vCard or SMS. It is preferable that business connection data processed to be a form of vCard or SMS is PIMS data than can be recognized by PIMS in the employee's terminal.

When the employee's terminal requests business connection data through the wireless data communication method, the main controlling part 401 processes business connection data to be a form of vCard and then provides processed business connection data through the wireless data communication method. In a similar way, when the main controlling part 401 produces a SMS having a URL of the company, the employee's terminal receives business connection data in a form of vCard by use of SMS call-back method.

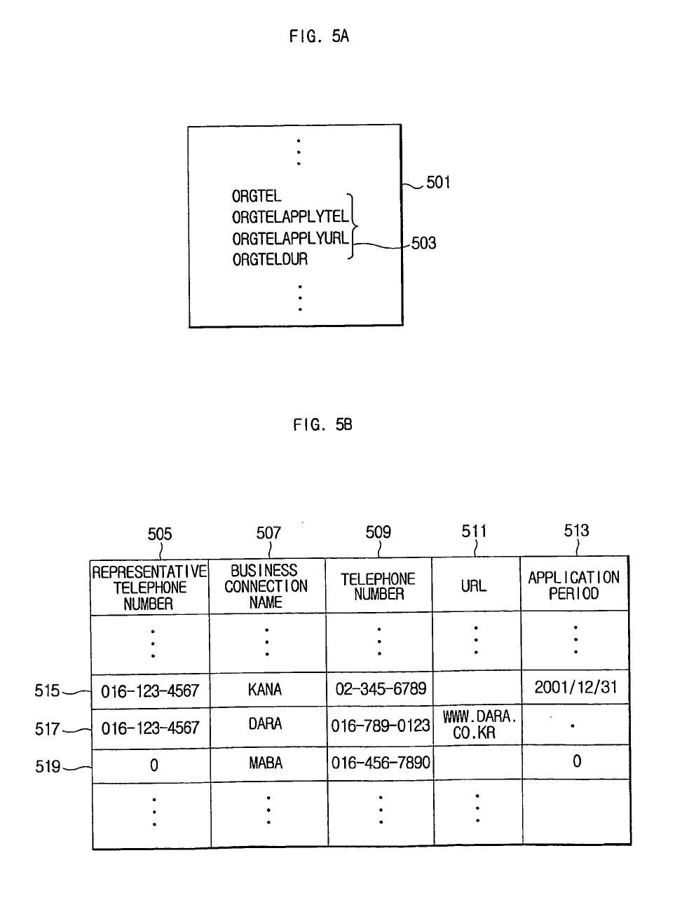

Hereinafter, the vCard will be described as follow. The vCard is a name of industrial standard for exchanging an electronic business card. The vCard can be transmitted with being attached to e-mail. The vCard is disclosed as the industrial standard so that application program developers can make a program for viewing the vCard to the user or processing vCard standard such as dragging and drop the vCard to the address book or other application programs. The vCard can include image or sound as well as text. vCard was developed by a consortium founded by Apple, AT&T, IBM, and Siemens, which turned the specification over to an industry group, the Internet Mail Consortium (IMC) in 1996. The vCard specification makes use of the “person” object defined by the CCITT X.500 Series Recommendation for Directory Services and can be considered an extension of it. A vCard contains a name, address information, date and time, and optionally photographs, company logos, sound clips, and geo-positioning information. The data fields of vCard in accordance with the present invention are described with reference of FIG. 5a.

FIG. 5a shows vCard data fields in accordance with the preferred embodiment of the present invention.

Referring to FIG. 5a, the vCard includes additional fields 503 as well as conventional data fields. The conventional data fields of vCard are well known in the art so that the detailed description will be omitted. The additional fields 503 include ORGTEL, ORGTELAPPLYTEL, ORGTELAPPLYURL and ORGTELDUR. Here, ORGTEL represents billing target information. Billing target information is one selected from a group consisting of representative company information and deletion information. ORGTELAPPLAYTEL represents a telephone number that billing target information will be applied to. ORGTEIAPPLYURL represents URL that billing target information will be applied to. And, ORGTELDUR represents the period that how long the billing according to the present invention is applied. The names and concrete contents of data fields of vCard may be changed variously, however, theses variations cannot escape from the sprit and scope of the present invention.

Referring to FIG. 4 again, PIMS data that is processed as a form of vCard by the main controlling part 401 will be described with reference of FIG. 5b.

FIG. 5b shows PIMS data according to the vCard form in accordance with the preferred embodiment of the present invention.

Referring to FIG. 5b, PIMS data according to the vCard form includes a representative telephone number 505, a part of business connection name 507, a telephone number 509, a part of URL 511 and a part of application period 513. The representative telephone, the telephone number, URL and the application period correspond to ORGTEL field, ORGTELAPPLYTEL field, ORGTELAPPLYURL field and ORGTELDUR field respectively.

When the concrete examples of business connection data applied to each field are closely examined, there are KANA incorporation data 515, DARA incorporation data 517 and MABA incorporation data 519.

In KANA incorporation data 515, 016-123-4567 is shown on the representative telephone number 505. In this case, if the communication to 02-345-6789, which is telephone number of KANA incorporation, is serviced on the employee's terminal, the communication charge for service use is billed to the representative telephone number 016-123-4567. The application period 513 is Dec. 31, 2001 so that the communication charge for service use after Dec. 31.2001 to 02-345-6789, which is the telephone number of the KANA incorporation, may be billed to the employee.

In DARA incorporation data 517, 016-123-4567, 016-789-0123 and www.dara.co.kr are shown on the representative telephone 505, the telephone number and URL respectively. In this case, if the communications to 016-123-4567 and www.dara.co.kr, which are telephone number of DARA incorporation and URL respectively, are serviced on the employee's terminal, the communication charge for service uses is billed to the representative telephone number 016-123-4567.

In MABA incorporation data 519, two 0 are shown on the representative telephone 505 and the application period respectively. In this case, if the communication to 016-456-7890, which is telephone number of MABA incorporation, is serviced on the employee's terminal, the communication charge for service use is billed to not the representative telephone number 016-123-4567 but the employee. That is, 0 on the representative telephone number may represent aforementioned deletion information.

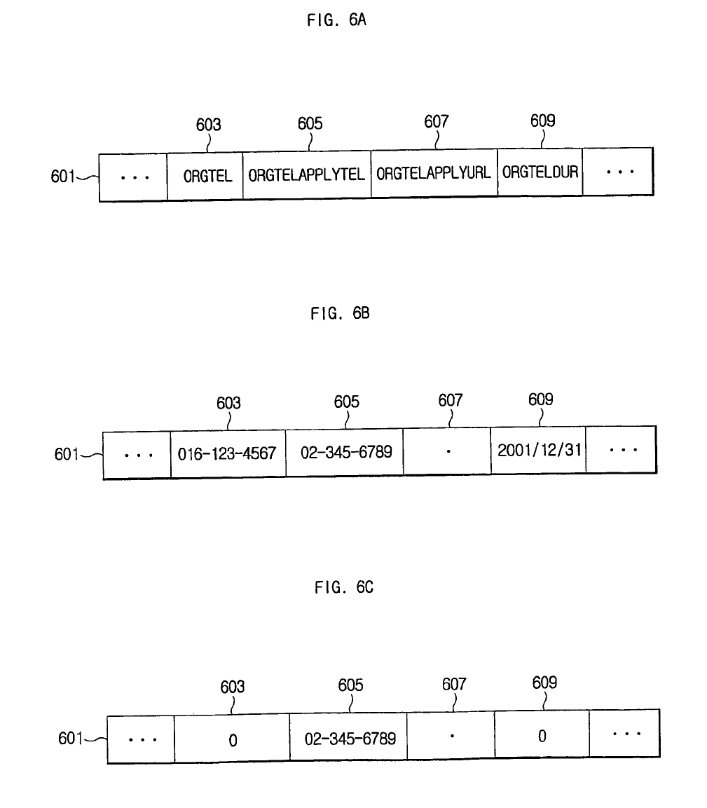

FIG. 6a shows fields of SMS data in accordance with the preferred embodiment of the present invention.

When the employee's terminal requires business connection data through the SMS method, the main controlling part 401 processes business connection data to be a form of SMS and then provides it to the employee's terminal. It is preferable to provide business connection data in the form of vCard and through the wireless data communication method, but, for this, the employee's terminal must be a wireless Internet terminal. Also, the company must purchase intranet solution. Even if the employee's terminal is not a wireless Internet terminal or the company does not purchase intranet solution, when there are needs for processing an urgent task or registering business connection data at once, business connection data can be processed to be the form of SMS and then provided to the employee's terminal.

SMS data 601 includes ORGTEL field 603, ORGTELAPPLYTEL field 605, ORGTELAPPLYURL field 607 and ORGTELDUR field 609. Each field is same as aforementioned fields so that the detailed description will be omitted.

FIG. 6b and FIG. 6c show PIMS data according to SMS form in accordance with the preferred embodiment of the present invention.

Referring to FIGS. 6b and 6c, PIMS data according to SMS form includes a representative telephone number 603, a telephone number 605, a part of URL 607 and an application period 609. The representative telephone number, the telephone number, URL and the application period correspond to ORGTEL field, ORGTELAPPLYTEL field, ORGTELAPPLYURL field and ORGTELDUR field respectively.

Each concrete example is similar to the description of FIG. 5b so that the detailed description will be omitted.

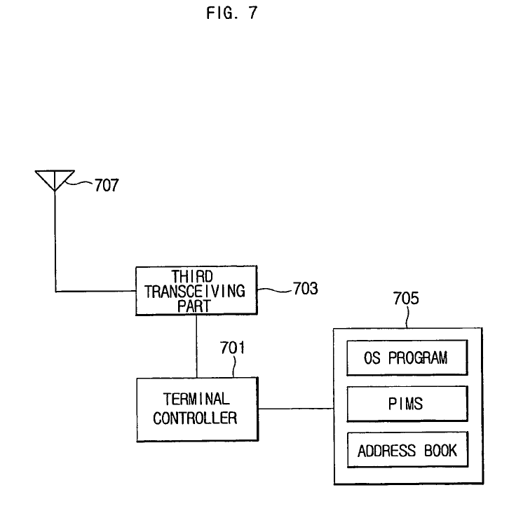

FIG. 7 is a schematic of the employee's terminal in accordance with the preferred embodiment of the present invention.

Referring to FIG. 7, the employee's terminal includes a terminal controller 701, storage 705, the third transceiving part 703 and an antenna 707. Here, the third transceiving part 703 and antenna 707 perform same function of the conventional wireless terminal so that the detailed description will be omitted.

OS, PIMS and address book are stored in the storage 705. OS is a conventional matter so that detailed description will be omitted. PIMS is an application program that lets computer user manage personal information easily. PIMS provides many functions from brief memo in text form to special day manager, business card manager, schedule manager, calendar, calculator and so on. There is an ORGERNIZER from Lotus as a representative PIMS product. Recently, there is an application program that provides a function of managing personal information through WEB. These PIMS performs a function of extracting necessary business connection data from business connection data in the form of vCard or SMS, which is transmitted from the company, and inputs extracted business connection data in the address book. Business connection data is stored in the address book. Of course, it is apparent that necessary data of employee himself/herself can be stored in the address book.

The terminal controller 701 performs a function of determining billing target in accordance with the preferred embodiment of the present invention as well as generally controlling the storage 705, the third transceiving part 703 and the antenna 707. The method for determining the billing target will be described with reference of drawing.

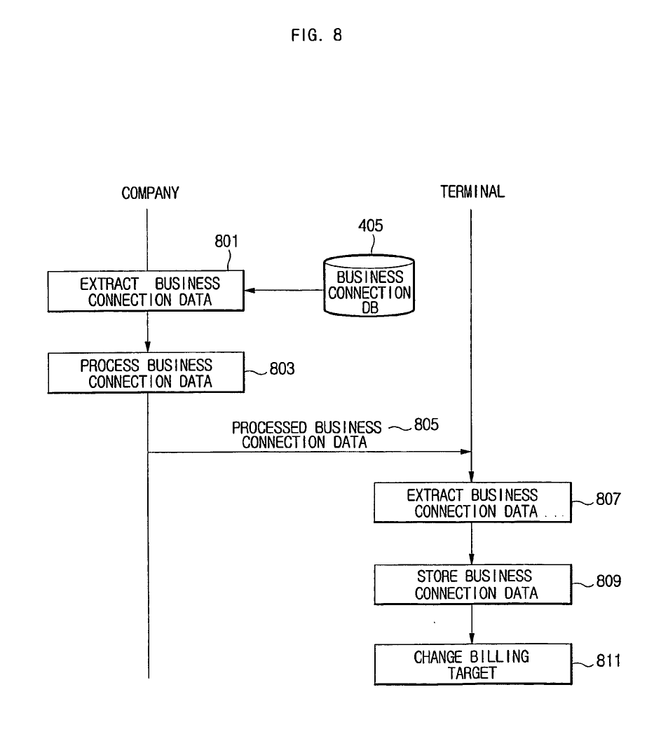

FIG. 8 is a flow chart for showing the process of determining the billing target in accordance with the preferred embodiment of the present invention.

Referring to FIG. 8, the company extracts business connection data from its internal business connection database 405 (step 801). The company processes extracted business connection data to be a form of PIMS data such as vCard or SMS that can be recognized by PIMS in the employee's terminal (step 803). Then the company transmits processed business connection data to the employee's terminal (step 805). The transmission of processed business connection data can be performed through the wireless data communication method, the SMS method or the SMS call-back method. These methods are already described so that the detailed description will be omitted.

On receiving processed business connection data transmitted from the company, the employee's terminal controller extracts business connection data from processed business connection data by use of PIMS installed in the employee's terminal (step 807). Then the controller of the employee's terminal stores extracted business connection data in the address book provided in the terminal (step 809). The terminal controller changes the billing target by use of billing target information in business connection data (step 811).

In the case of a mobile communication service, the method for changing the billing target will be described with an example. After extracting billing target information (especially, the company's representative telephone number as representative company information), the terminal controller updates MIN(Mobile Identification Number; employee's terminal number is stored in the MIN) of the access channel with extracted billing target information. The billing target is changed through aforementioned step. That is, in the case that the employee's terminal uses a communication service through the access channel, the charge for communication service use is billed to the billing target that is updated in the MIN of the access channel. Under the state that the company is the billing target, the process that updates the billing target with the employee's terminal number by use of deletion information may be fully understood with aforementioned steps, so that the detailed description will be omitted. Here, though we described change MIN of access channel as an example, however, if the substance is to change or determine the billing target, it doesn't matter what kind of terms and software are used.

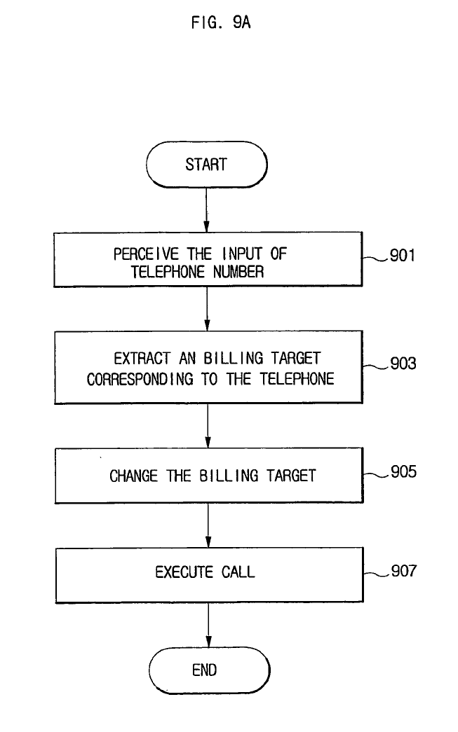

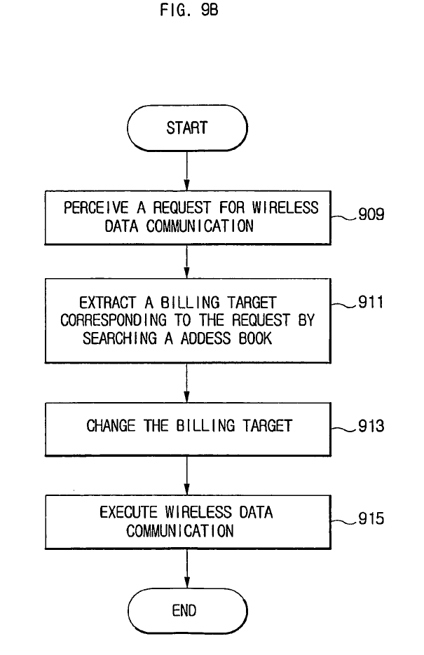

FIG. 9a is a flow chart showing the method for changing the billing target in using a voice call service and SMS in accordance with the preferred embodiment of the present invention.

Referring to FIG. 9a, the employee's terminal perceives the input of telephone number (step 901). The telephone number can be inputted through a keypad. Here, it is preferable that the inputted telephone number is the business connection number. The employee's terminal searches the address book that is stored in the internal storage and extracts the billing target corresponding to the inputted telephone number (step 903). The employee's terminal changes the billing target for the extracted billing target according to the aforementioned method for changing billing target (step 905). Then, the employee's terminal executes a call when there is an input of call request (step 907). The charge for call execution is billed to the changed billing target.

FIG. 9b is a flow chart showing the method for changing the billing target in using a wireless data communication service in accordance with the preferred embodiment of the present invention.

Referring to FIG. 9b, the employee's terminal perceives an input of URL as Internet or intranet access request, that is, a wireless data communication request (step 909). The URL can be inputted through a keypad. The employee's terminal searches the address book that is stored in the internal storage and extracts the billing target corresponding to the inputted URL (step 911). The employee's terminal changes the billing target for the extracted billing target according to the aforementioned method for changing billing target (step 913). Then, the employee's terminal executes a call when there is an input of service execution request (step 915). The charge for wireless data communication is billed to the changed billing target.

While the present invention has been described with reference to the preferred embodiments thereof, those skilled in the art appreciate the fact that various changes in form and detail may be made without departing from the present invention as defined in the appended claims nevertheless.

### INDUSTRIAL APPLICABILITY

As aforementioned, according to the present invention, the charges for communication services for official business related to the company among the whole communication services used by the employees are billed to the company, so that the company can save the cost related to the communication.

Also, according to the present invention, even though the employee called to the business connections with his/her communication terminal, the employee does not need to pay the charges for the communication uses related to the official business.

Also, according to the present invention, it is possible to divide and bill the billing target in a SMS and a wireless data communication service as well as a conventional voice call.

Also, the present invention changes the billing target by changing the terminal's software, so that there is no need to change the conventional billing system provided with a plurality of switchboards and wireless data communication equipments of the service provider and as a result can save the cost required to change the billing system.

Also, the present invention can change the billing target collectively by use of PIMS data in the forms of vCard or SMS without changing the billing target one-by-one.

1. A method for determining a billing target in a first subscriber's terminal in order to bill the first subscriber's communication charge, said method comprising the steps:
receiving a business connection data from a second subscriber corresponding to the first subscriber, wherein the business connection data comprises business connection access information and billing target information for billing;
storing the received business connection data in a storage; and
updating the billing target by use of the billing target information,
wherein the charge for communication service through the business connection access information is billed the billing target.

2. The method as stated in claim 1, wherein the business connection data is PIMS(Personal Information Management System) data that is selected from a group consisting of vCard form and SMS(Short Message Service) form, wherein the terminal is provided with PIMS.

3. The method as stated in claim 2, wherein the business connection data can be received through at least one method selected from a group consisting of a wireless data communication method, a SMS method and a SMS call-back method.

4. The method as stated in claim 1, wherein the business connection data further comprises a billing-application period.

5. The method as stated in claim 1, wherein the business connection access information is one selected from a group consisting of a business connection telephone number, a business connection URL.

6. The method as stated in claim 1, wherein the billing target information is one selected from a group consisting of a second subscriber representative information for updating the second subscriber as a billing target and a deletion information for deleting the second subscriber from the billing target.

7. The method as stated in claim 6, wherein the second subscriber representative information is a representative telephone number corresponding to the second subscriber.

8. A terminal for determining a billing target in a first subscriber's terminal in order to bill the first subscriber's communication charge, said terminal comprising:
means for receiving a business connection data from a second subscriber corresponding to the first subscriber, wherein the business connection data comprises business connection access information and billing target information for billing;
means for storing the received business connection data in a storage; and
means for updating the billing target by use of the billing target information,
wherein the charge for communication service through the business connection access information is billed the billing target.

9. A computer-readable medium including a program containing computer-executable instructions for performing the method for determining a billing target in a first subscriber's terminal in order to bill the first subscriber's communication charge, wherein the program practices the steps of:
receiving a business connection data from a second subscriber corresponding to the first subscriber, wherein the business connection data comprises business connection access information and billing target information for billing;
storing the received business connection data in a storage; and
updating the billing target by use of the billing target information,
wherein the charge for communication service through the business connection access information is billed the billing target.

10. A method for providing a business connection data for determining a billing target in a terminal of a second subscriber corresponding to a first subscriber in order to bill the first subscriber's communication charge, said method comprising the steps of:
extracting the business connection data from a business connection database;
processing the extracted business connection data; and
transmitting the processed business connection data to a terminal corresponding to the first subscriber, wherein the business connection data comprises business connection access information and billing target information for billing,
wherein the business connection data is stored in the terminal, the billing target is updated by use of the billing target information and the charge for communication service through the business connection access information is billed the billing target.
